(19) United States
(12) Patent Application Publication
(10) Pub. No.: US 2004/0056396 A1
(43) Pub. Date: Mar. 25, 2004

(54) Air spring with rolling bellows secured to a rolldown tube

(76) Inventor: Hans Brandl, Weichering (DE)

Correspondence Address: Peter N. Lalos, Kenneth J. Whittington, Stevens, Davis, Miller & Mosher, LLP, 1615 L Street, NW, Suite 850, Washington, DC, 20036-5622, US

(21) Appl. No.: 10/645,592

(22) Filed: Aug. 22, 2003

(30) Foreign Application Priority Data
Aug. 23, 2002 (DE) 102 38 666.8

(51) Int. Cl. F16F 9/04

(52) U.S. Cl. 267/64.24

(57) ABSTRACT

The invention relates to a air spring (10) having a rolling bellows (12) secured to a rolldown tube (16), one surface of which (rolldown surface) of which rolling bellows (12) comes into contact with an associated surface (contact surface) of the rolldown tube (16) area by area with increasing compression of the air spring (10). The invention is characterized in that the contact surface of the rolldown tube (16) is in the form of a spring element (26).

The invention relates to an air spring with rolling bellows secured to a rolldown tube of the type specified in the preamble of claim 1.

An air spring such as this is disclosed in DE 100 04 122 A1, for example. A rolling bellows is connected to a rolldown tube. The external surface of the rolling bellows comes in contact with the rolldown tube area by area with increasing compression. The rolldown tube consists of a base element and a jacket serving as a drainage element surrounding the base element. Formation of a film of moisture on the rolling bellows promoting corrosion is prevented by the drainage element. The drainage element consists of recesses or grooves or several openings made in the wall of the rolldown tube and ensures discharge by way of an opening or a plurality of openings arranged in the wall of the rolldown tube.

A generic air spring is disclosed in DE 100 60 824 A1 as well. The exterior of the rolldown tube, which is associated with the exterior of the rolling bellows, which is applied to the outer surface with the increasing compression of the air spring, is grooved, that is, provided with alternating recesses and projections. Reduction of the dead weight of the rolldown tube is achieved as a result of the grooving.

Springs of this type are used as vehicle spring systems chiefly in trucks for example but also in passenger automobiles. The forces exerted radially by the rolling bellows on the pressurized rolldown tube are absorbed by the exterior of the rolldown tube. The rolling bellows rolls up and down more or less on the exterior of the rolldown tube during the spring deflection process.

However, a problem encountered with this type of spring suspension is inadequate rolldown comfort in the area of higher frequency excitation—roughness, harshness behavior—due to dynamically high rigidities of the rolling bellows. Appreciable improvement in the rolldown comfort could be achieved on the basis of the state of the art by having the rolling bellows supported on the outer circumference by a cylinder. Application of this measure makes it possible to employ much softer rolling bellows which do not exhibit the disturbing dynamic rigidification. Disadvantages are represented, of course, by an appreciably greater structural space requirement and the increase in weight due to the cylinder.

The object of the invention is further to develop an air spring with rolling bellows mounted on a rolldown tube as specified in the preamble of claim 1 in such a way that the rolldown behavior is improved and the vibrations occurring over the rolling bellows during compression are reduced while the disadvantages referred to are avoided.

This object is attained by the characteristics specified in claim in connection with the features specified in the preamble of this article.

The dependent claims specify advantageous developments of the invention.

The invention is based on the finding that the vibrations occurring during rolldown can be substantially reduced by provision of a spring element associated with the rolldown surface of the rolling bellows.

It is accordingly claimed for the invention that the air spring has a rolling bellows secured to a rolldown tube, one surface of the rolling bellows, the rolldown surface, comes into contact with an associated surface, the contact surface, of the rolldown tube with area by area with increasing compression of the air spring and the contact surface of the rolldown tube being a spring element. The purpose of this spring element is to press the rolling bellows gently against the rolldown tube in the transverse direction, that is, in the direction of the circular fold, and thereby significantly to reduce the dynamic rigidity of this fold.

In particular, the exterior of the rolldown tube represents the contact surface and the exterior of the rolling bellows represents the rolldown surface.

By preference the spring element acts at least in the radial direction with respect to the rolldown tube. Consequently, the higher frequency vibrations induced by the compression process in the range of approximately 25 to 100 Hz, vibrations which are otherwise transmitted to the vehicle body, are significantly dampened.

In one embodiment of the invention the spring element rests on a base element of the rolldown tube, being detachably connected to the base element. As a result, the spring characteristics for damping the rolling bellows during rolldown, that is, with increase in the compression of the air spring, may be determined by simple means in accordance with the type of material.

In order to permit simple mounting of the spring element on the base element, there is in this base element a recess into which the spring element is form fitted, at least with respect to the axial extent of the base element. Simplicity of assembly and disassembly is thereby ensured.

On the basis of the properties favoring vibration and acoustic insulation of the spring element, preferably polyurethane foam may be selected as the material for this element. Use may also be made, however, of other flexible materials, such as an elastomer, rubber, and the like, for formation of the spring element.

In addition, the damping properties of the spring element may be enhanced by shaping, that is profiling, both of the area of contact with the rolling bellows and that of the area of contact with the base element of the rolldown tube, or of the area of contact of both.

In one embodiment of the invention the base element of the rolldown tube is connected to a base from which it extends vertically upward. In order to shield this base element from mechanical effects, the spring element covers the exterior of the base element in its entirety.

For example, in order that the requirement of better protection from corrosion may be met the spring element is configured as a drainage element which has one or more openings in the lower area for discharge of fluids. The spring element may then have the configuration disclosed in DE 100 04 122 A1.

Additional advantages and features are set forth in the description of one embodiment of the invention in connection with the drawing, in which

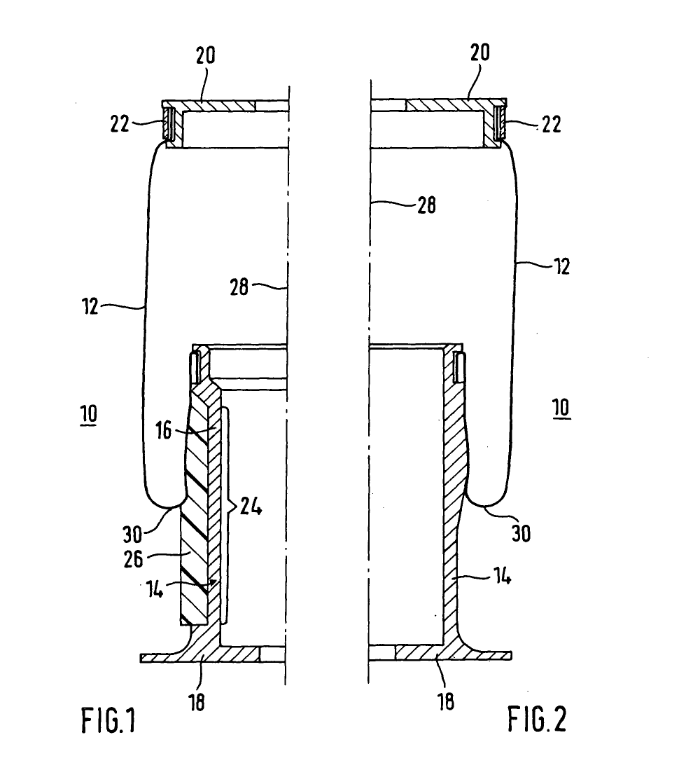

FIG. 1 presents a cross-sectional view of one half of an air spring as claimed for the invention, and

FIG. 2 a cross-sectional view of one half of an air spring which is of the state of the art.

FIG. 1 shows in a cross-sectional view one half of an air spring 10, while FIG. 2 also shows an air spring 10, but one based on the state of the art.

Identical reference numbers apply to the same elements of the air springs 10 shown in FIGS. 1 and 2. The comparison illustrates the difference between the invention and the state of the art.

The air spring 10 is provided with a rolling bellows 12 which is secured on a base element of a rolldown tube 16. The base element 14 is cylindrical in shape and extends vertically upward from a disk-shaped base 18.

At its end opposite the base element the rolling bellows 12 is connected to a support 20.

The base 18 may be secured on the axle or wheel side in the vehicle and the support 20 on the vehicle frame or chassis.

The rolling bellows 12 is rigidly connected to the support 20 by a clamping ring 22.

The rolldown tube 16 claimed for the invention is provided with a recess 24 in the base element 14 into which is introduced a spring element 26 completely enclosing the base element 14 as a jacket. The recess 24 is formed by an offset of the cylindrical rolldown tube 16, the offset extending diagonally in the upper area of the recess 24. The spring element 26 is retained axially in the recess 24 by positive locking.

The spring element 26 is mounted concentrically with the center shaft 28 of the air spring 10 and acts radially outward, especially in the direction of the lower fold 30 of the rolling bellows 12.

As the compression of the air spring 10 increases, that is, as the support 20 moves in the direction of the base 18, the rolling bellows 12 rolls by its outer, rolldown, surface down the associated, contact surface of the spring element 26. Use of the spring element 26 makes it possible, as a result of compression of this spring element 26 and rolling of the rolling bellows 12 down the contact surface, to dampen the vibrations which occur (see FIG. 1).

In contrast to this configuration, the state-of-the-art rolling bellows 12 rolls down the external surface of the rolldown tube 16 without damping. Vibrational disturbance occurs as a result (see FIG. 2).

In one embodiment of the invention not illustrated here the spring element may be configured as a drainage element, to provide the possibility of removing films of moisture formed on the rolling bellows 12. In addition, the surface of the spring element 26 or the inner contact surface of the spring element 26 down to the base element 14 may be designed to be grooved.

The invention is distinguished by the simple possibility of preventing in advance potential vibrations occurring during compression of the air spring 10.

### REFERENCE NUMBER LIST

10 air spring

12 rolling bellows

14 base element

16 rolldown tube

18 base

20 support

22 clamping ring

24 recess

26 spring element

28 center shaft

30 fold of rolling bellows

1. An air spring (10) having a rolling bellows (12) secured to a rolldown tube (16), one surface of which (rolidown surface) of which rolling bellows (12) comes into contact with an associated surface (contact surface) of the rolldown tube (16) area by area with increasing compression of the air spring (10), characterized in that the contact surface of the rolldown tube (16) is in the form of a spring element (26).

2. The air spring as claimed in claim 1, wherein the contact surface is in the form of the exterior of the rolldown tube (16) and the rolldown surface is in the form of the exterior of the rolling bellows (12).

3. The air spring as claimed in claim 1 or 2, wherein the spring element (26) operates at least in a radial direction in relation to the rolldown tube (16).

4. The air spring as claimed in one of the foregoing claims, wherein the spring element (26) is mounted on a base element (14) of the rolldown tube (16).

5. The air spring as claimed in claim 4, wherein the spring element (26) is detachably connected to the base element (14).

6. The air spring as claimed in claim 4 or 5, wherein the base element (14) has a recess (24) in which the spring element is positively locked at least with respect to the axial extent of the base element (14).

7. The air spring as claimed in one of the foregoing claims, wherein the spring element (26) consists of a polyurethane foam, an elastomer, rubber, and/or the like.

8. The air spring as claimed in one of the foregoing claims, wherein the exterior and/or the interior of the spring element (26) is configured to be grooved.

9. The air spring as claimed in one of the foregoing claims, wherein the base element (14) of the rolldown tube (16) is connected to a base from which it extends vertically upward.

10. The air spring as claimed in claim 9, wherein the exterior of the base element (14) is covered in its entirety by the spring element (26).

11. The air spring as claimed in one of the foregoing claims, wherein the spring element (26) is designed as a drainage element which has one or more openings in the lower area for discharge of fluids.
